(19) United States
(12) Patent Application Publication
(10) Pub. No.: US 2009/0092503 A1
(43) Pub. Date: Apr. 9, 2009

(54) VALUE STRUCTURE

(75) Inventors: Hsien-Kai Meng, Taoyuan Hsien (TW); Shu-Pin Hsien, Taoyuan Hsien (TW); Chien-Hua Lin, Taoyuan Hsien (TW); Yu-Chung Hsu, Taoyuan Hsien (TW); Tai-Hsuan Lin, Taoyuan Hsien (TW)

Correspondence Address: APEX JURIS, PLLC, 12733 LAKE CITY WAY NORTHEAST, SEATTLE, WA, 98125, US

(73) Assignee: MICROBASE TECHNOLOGY CORP., Taoyuan Hsien (TW)

(21) Appl. No.: 12/115,732

(22) Filed: May 6, 2008

(30) Foreign Application Priority Data
Jun. 7, 2007 (TW) 096120445

(51) Int. Cl. F04B 43/04; F16K 1/12; F16K 1/32; F04B 35/04; F16K 27/02

(52) U.S. Cl. 417/322; 251/331; 251/333; 251/356; 251/368

(57) ABSTRACT

A valve structure includes a valve opening diaphragm and a valve diaphragm. The valve opening diaphragm provides a central valve opening with a plurality of wave shaped projections at the circumference of the valve opening. The valve diaphragm stacks on the valve opening diaphragm and providing at least a pair of elongated circular grooves. The pair of circular grooves is symmetrically disposed with respect to the center of the valve diaphragm and an area enclosed by the pair of circular grooves covers the valve opening.

### FIELD OF THE INVENTION

The present invention is related to a piezoelectric type micro pump and particularly to a micro pump with a special valve structure.

### BACKGROUND OF THE INVENTION

The conventional valve structure shown in FIG. 7 provides a valve diaphragm 70, which has a central valve lid 700, and a valve opening diaphragm 72. When the central valve lid 700 is pushed by fluid to move an inclining angle so as to open the valve, the open stroke d near the bent position of the central valve lid 700 is smaller such that the effective flow path cross section becomes largely reduced. Besides, when the flow rate increases to result in the fluid having greater pushing force, the responding time for closing the central valve lid 700 becomes longer in spite of the effective flow path cross section becoming larger along with the open stroke d increasing due to larger inclining angle being obtained. Hence, the integral efficiency of opening and closing for the valve becomes lower.

Another conventional valve structure 8 illustrated in FIG. 8 provides a valve diaphragm 80 with a central valve lid 800 and the central valve lid 800 has a connecting rib to produce elongation at the time of the fluid pushing the central valve lid 800. However, the pushing force of the fluid is often uneven such that the central valve lid 800 is incapable of opening in a way of parallel to the valve opening diaphragm. Consequently, the effective flow path cross section decreases and the integral efficiency of opening and closing for the valve is undesirable too.

### SUMMARY OF THE INVENTION

An object of the present invention is to provide a valve structure with which a larger effective flow path cross section can be obtained to enhance efficiency of opening and closing significantly.

Another object of the present invention is to provide a micro pump using the valve structure of the present invention.

In order to achieve the preceding objects, a valve structure according to the present invention includes a valve opening diaphragm and a valve diaphragm. The valve opening diaphragm provides a central valve opening with a plurality of wave shaped projections at the circumference of the valve opening. The valve diaphragm stacks on the valve opening diaphragm and providing at least a pair of elongated circular grooves. The pair of circular grooves is symmetrically disposed with respect to the center of the valve diaphragm and an area enclosed by the pair of circular grooves covers the valve opening.

Next, a valve structure according to the present invention includes a valve opening diaphragm and a valve diaphragm. The valve opening diaphragm provides a plurality of valve openings being disposed equidistantly surrounding the center thereof. The valve diaphragm stacks on the valve opening diaphragm and provide a central hole and at least a pair of elongated circular grooves. The pair of circular grooves are symmetrically disposed with respect to the center of the valve diaphragm and has an area surrounding the central hole and enclosed by the pair of circular grooves for covering the valve openings.

Besides, a micro pump for conveying fluid according to the present invention comprises a casing, which provides a first internal chamber, an entry and an exit, a piezoelectric actuating element, which is disposed at the first internal chamber to compress a space in the first internal chamber, and a plurality of valve parts, which is disposed at the entry and the exit respectively; wherein the valve parts further at least comprises a valve opening diaphragm, which provides a central valve opening with a plurality of wave shaped projections at the circumference of said valve opening, and a valve diaphragm, which stacks on the valve opening diaphragm and provides at least a pair of elongated circular grooves; wherein, the pair of circular grooves are symmetrically disposed with respect to the center of the valve diaphragm and an area enclosed by the pair of circular grooves covers the valve opening.

Further, a micro pump for conveying fluid according to the present invention comprises a casing, which provides a first internal chamber, an inlet and an outlet, a piezoelectric actuating element, which is disposed at the first internal chamber to compress a space in the first internal chamber, and a plurality of valve parts, which are disposed at the inlet and the outlet respectively; wherein the valve parts further at least comprises a valve opening diaphragm, which provides a plurality of valve openings disposed equidistantly at the center thereof, and a valve diaphragm, which stacks on the valve opening diaphragm and provides a central hole and at least a pair of elongated circular grooves; wherein, the pair of circular grooves are symmetrically disposed with respect to the center of the valve diaphragm and has an area surrounding the central hole and enclosed by the pair of circular grooves for covering the valve openings.

### BRIEF DESCRIPTION OF THE DRAWINGS

The detail structure, the applied principle, the function and the effectiveness of the present invention can be more fully understood with reference to the following description and accompanying drawings, in which:

FIG. 1A is an exploded perspective view of a first embodiment of a valve according to the present invention;

FIG. 1B is an assembled perspective view of the valve shown in FIG. 1A;

FIG. 1C to 1G are plan views of valve diaphragms illustrating the valve opening with two to six wave projections respectively;

FIG. 1H is a sectional view illustrating the first embodiment of a valve according to the present invention in a state of closing;

FIG. 1I a sectional view illustrating the first embodiment of a valve according to the present invention in a state of opening;

FIG. 2A is an exploded perspective view of the second embodiment of a valve according to the present invention;

FIG. 2B is an assembled perspective view of the valve shown in FIG. 2A;

FIG. 2C to 2G are plan views of valve diaphragms illustrating two to six valve openings being provided respectively;

FIG. 2H is a sectional view illustrating the second embodiment of a valve according to the present invention in a state of closing;

FIG. 2I a sectional view illustrating the second embodiment of a valve according to the present invention in a state of opening;

FIG. 3A is a perspective view of a micro pump adopting the valve of the present invention;

FIG. 3B is an exploded perspective view of the micro pump shown in FIG. 3A;

FIG. 3C is a perspective view of the casing of the micro pump projecting from the top thereof;

FIG. 3D is a perspective view of the casing of the micro pump projecting from the bottom thereof;

FIG. 3E is a perspective view of a variation embodiment of the micro pump shown in FIG. 3A;

FIG. 3F is a perspective view of a further variation embodiment of the micro pump shown in FIG. 3A;

FIG. 4A is perspective view of the inlet path cover in the micro pump shown in FIG. 3A;

FIG. 4B is perspective view of the outlet path lid disposed in the micro pump shown in FIG. 3A;

FIG. 4C is perspective view of the casing in association with the inlet path lid and the outlet path lid;

FIG. 5A is a perspective view illustrating fluid entering the micro pump via the inlet;

FIG. 5B is a perspective view illustrating fluid passing through the inlet groove disposed at the inlet path lid of the micro pump;

FIG. 5C is a perspective view illustrating fluid flowing outward the inlet toward the outlet;

FIG. 5D is a perspective view illustrating fluid passing through the outlet groove disposed at the outlet path lid of the micro pump;

FIG. 5E is a perspective view illustrating fluid flowing outward the outlet;

FIG. 6 is a perspective view of a further variation embodiment of the micro pump shown in FIG. 3A;

FIGS. 7A and 7B are a perspective view and a sectional view of the conventional valve respectively; and

FIGS. 8A and 8B are a perspective view and a sectional view of another type of the conventional valve respectively.

### DETAILED DESCRIPTION OF THE INVENTION

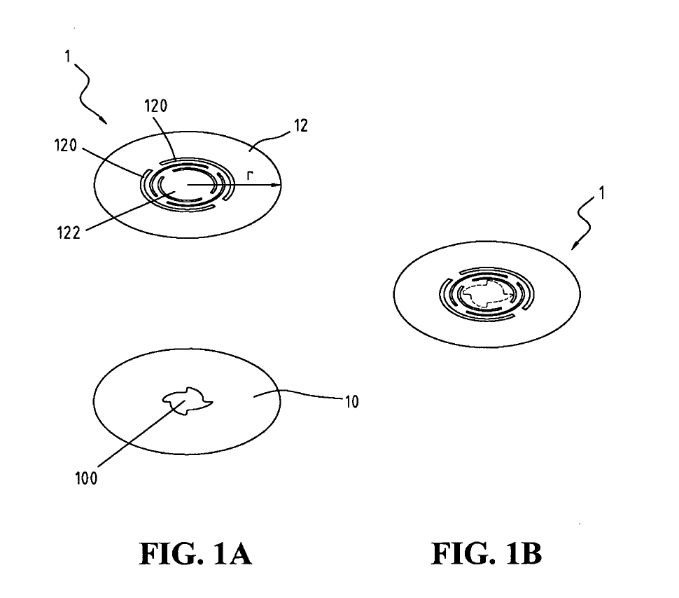

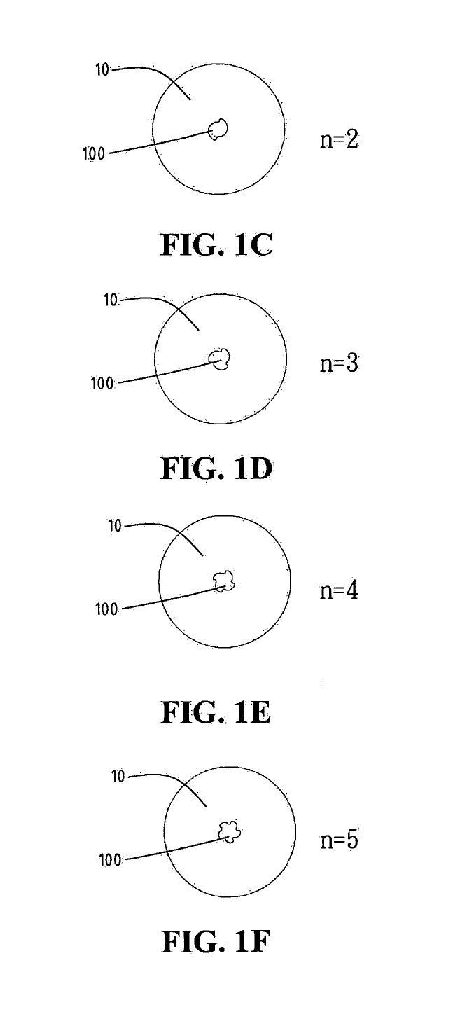

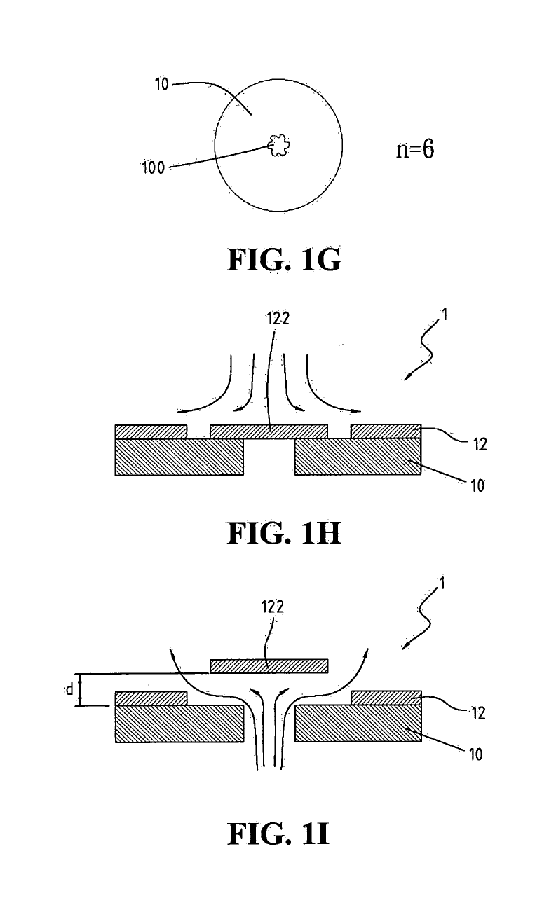

Referring to FIGS. 1A and 1B, the first embodiment of a valve structure according to the present invention is illustrated. It can be seen in FIGS. 1A and 1B that a valve 1 of the present invention includes a valve opening diaphragm 10 and a valve diaphragm 12. The valve opening diaphragm 10 has a valve opening 100 disposed at the center thereof with a plurality of wave shaped projections. There are four wave shaped projections shown in FIG. 1A. Nevertheless, it is noted that the number of wave shaped projections surrounding the valve opening 100 of the valve opening diaphragm 10 is capable being n and n=2,3,4, . . . ,360. FIGS. 1C, 1D, 1E, 1F and 1G show two, three, four, five and six wave shaped projections respectively. Besides, the valve diaphragm 12 is stacked on the valve opening diaphragm 10 and provides at least a pair of narrow circular grooves 120 symmetrically disposed to surround the center thereof and the area 122 enclosed with the circular grooves 120 is capable of covering the valve opening 100. It can be seen in FIG. 1A that the area 122 is a disk shaped zone, which includes the conventional annular shape or the like.

Operation of the valve 1 is recited in detail hereinafter. FIG. 1H illustrates the valve 1 is in a state of closing and FIG. 1I illustrates the valve 1 is in a state of opening. When fluid is going to flow toward the valve opening diaphragm 10 via the valve diaphragm 12, the area 122 enclosed by the circular grooves 120 is pushed by pressure of the fluid to block the valve opening 100 and the valve 1 becomes in a state of closing. Contrarily, when the fluid is going to move toward the valve diaphragm 12 via the valve opening diaphragm 10, the area 122 enclosed by the circular grooves 120 is pushed by the pressure of the fluid to move away from the valve opening 100 and the valve 1 becomes in a state of opening.

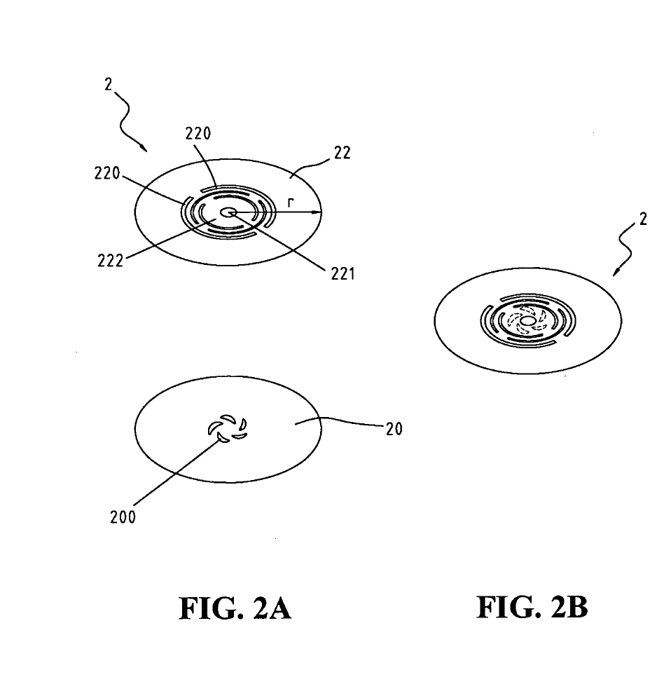

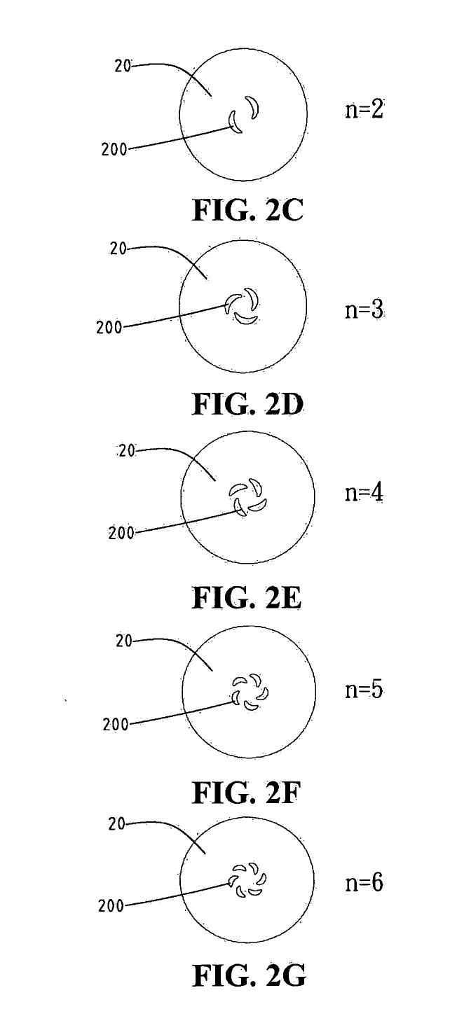

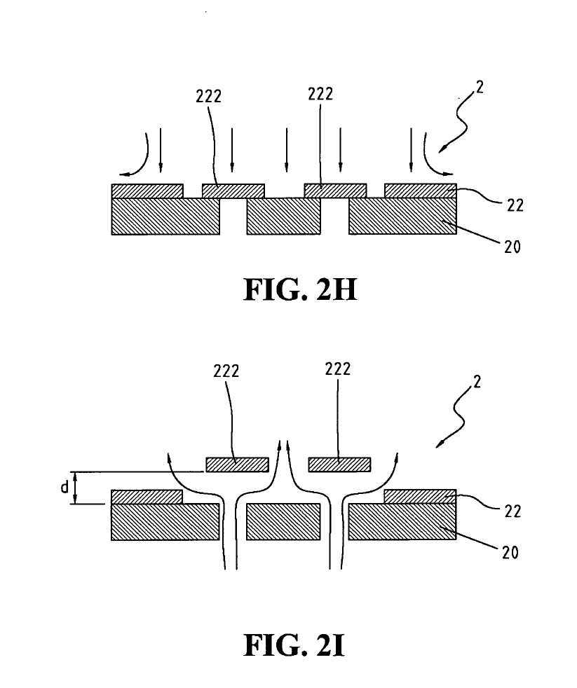

Referring to FIGS. 2A and 2B, the second embodiment of a valve structure according to the present invention is illustrated. It can be seen in FIGS. 2A and 2B that a valve 2 of the present invention includes a valve opening diaphragm 20 and a valve diaphragm 22. The valve opening diaphragm 10 has a plurality of valve openings 200 disposed to equidistantly surround the center thereof. There are five valve openings 200 shown in FIG. 1A and the valve openings 200 can be provided with a half-moon shaped aperture respectively. Nevertheless, it is noted that the number of the valve openings 200 of the valve opening diaphragm 20 is capable being n and n=2,3,4, . . . ,20,000 based on specific design. FIGS. 2C, 2D, 2E, 2F and 2G show two, three, four, five and six valve openings 200 respectively. Besides, the valve diaphragm 12 is stacked on the valve opening diaphragm 10 and provides a central hole 221 and at least a pair of narrow circular grooves 120 symmetrically disposed to surround the center of the central hole 221 and an area 222 between the circular grooves 120 and the central hole 221 is capable of covering the valve openings 100. It can be seen in FIG. 2A that the area 222 is a disk shaped zone, which includes the conventional annular shape or the like.

Operation of the valve 2 is recited in detail hereinafter. FIG. 2H illustrates the valve 2 is in a state of closing and FIG. 2I illustrates the valve 2 is in a state of opening. When fluid is going to flow toward the valve opening diaphragm 20 via the valve diaphragm 22, the area 222 enclosed by the circular grooves 220 is pushed by pressure of the fluid to block the valve opening 200 and the valve 2 becomes in a state of closing. Contrarily, when the fluid is going to move toward the valve diaphragm 22 via the valve opening diaphragm 20, the area 222 enclosed by the circular grooves 120 is pushed by the pressure of the fluid to move away from the valve opening 200 and the valve 2 becomes in a state of opening.

The features of the valve structure according to the present invention are supplemented hereinafter. The valve opening diaphragms 10, 20 in the first and second embodiments can be provided with a shape of triangle or polygon in addition to the thin disk shape (thin circular shape). Similarly, the valve diaphragms 12, 22 in the first and second embodiments can be provided with a shape of triangle or polygon in addition to the thin disk shape (thin circular shape). Besides, multiple pairs of circular grooves 120, 220 can be provided at the valve diaphragms 12, 22 shown in FIGS. 1A and 2A respectively and each pair of the circular grooves 120, 220 are arranged to be disposed equidistantly with the same radius r with respect to the center of the valve diaphragm 12, 22. In order to avoid phenomenon of wearing after a long period of operation, the valve opening diaphragms 10, 20 and the valve diaphragms 12, 22 are made of polytetrachlorethylene, polyether-ether-ketone, polyimide, polyetherimide, or high grade engineering plastics to intensify durability. Furthermore, the thickness of the respective valve opening diaphragm 10, 20 has a range between 0.1 μm and 500 μm and the thickness of the respective valve diaphragm 12, 22 has a range between 1 μm and 2000 μm.

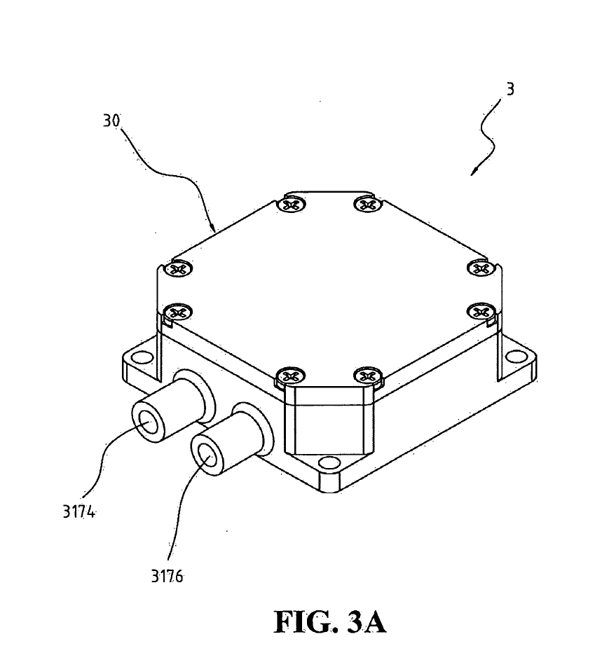

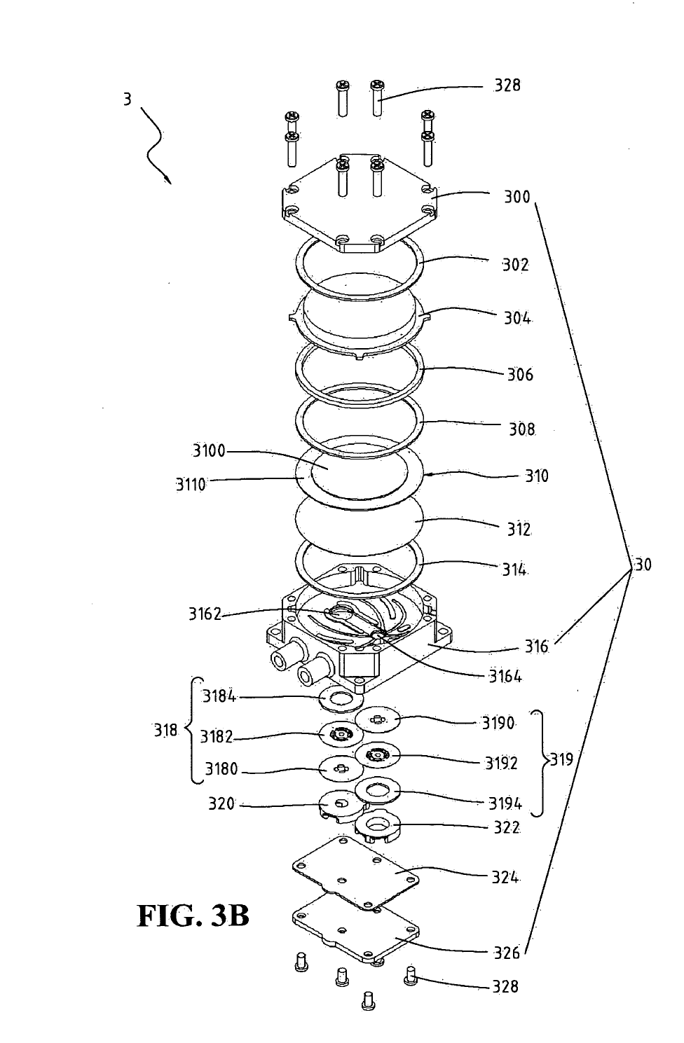

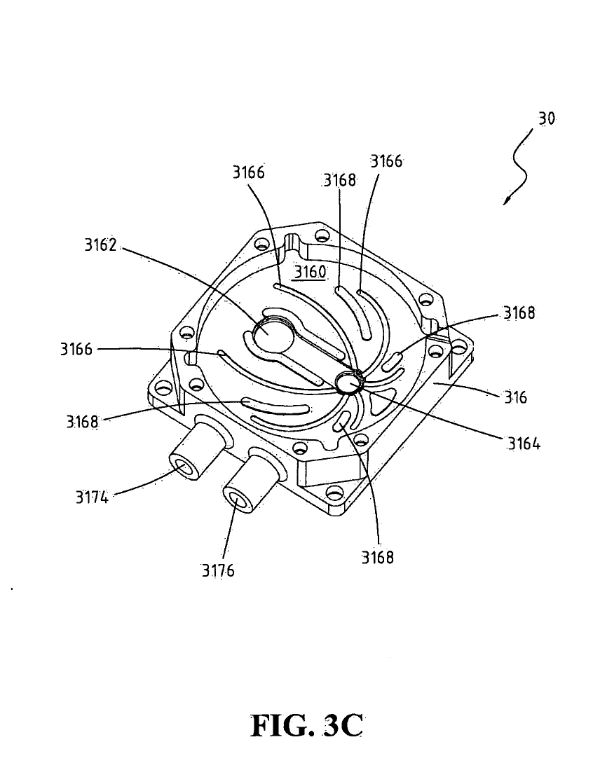

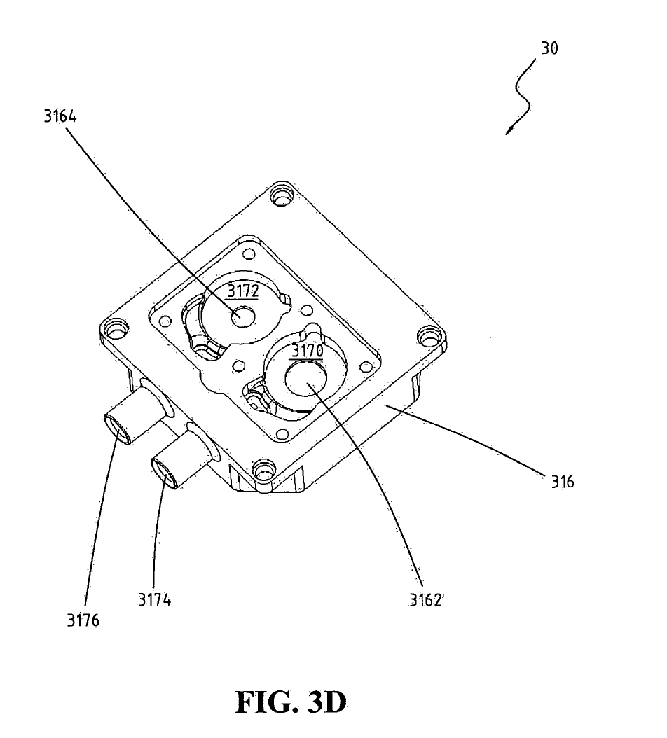

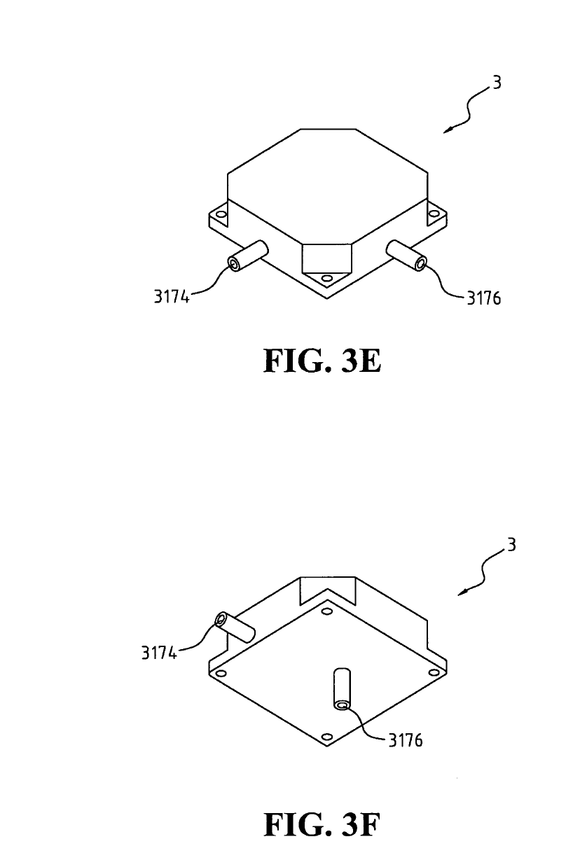

Referring to FIGS. 3A and 3B, a micro pump 3, which employs the valve of the present invention, is illustrated. The micro pump 3 delivers fluid including liquid and gas. The liquid can be such as diesel oil, gasoline, methanol, alcohol, pure water, methanol solution, alcohol solution, chemical liquid drug and sea water. The gas can be natural gas, hydrogen, pure oxygen, air and carbon oxide. It can be seen in FIG. 3B, the micro pump 3 includes a casing 30, a piezoelectric actuating element 310 and valve parts 318, 319. The casing 30 provides an upper cover plate 300 and a lower lid 326 except a main body 316. Referring to FIGS. 3C and 3D in company with FIGS. 3A and 3B, the casing 30 has a first internal chamber 3160, an inlet 3162 and an outlet 3164. Besides, the bottom wall of the internal chamber 3160 has a plurality of guiding flow projections 3168 and leading recesses 3166. The leading recesses 3166 extending outward from the outlet 3164 and the guiding projections 3168 are disposed between the leading recesses 3166. The guiding flow projections 3168 and the leading flow recesses 3166 in the instant embodiment provide a function of guiding the fluid to the outlet 3164 from the inlet 3162 rapidly. It can be seen in FIG. 3D that the casing 30 has a primary second internal chamber 3170, a secondary internal chamber 3172, a fluid entry 3174 and a fluid exit 3176. The fluid entry 3174 communicates with the primary second internal chamber 3170 and the fluid exit 3176 communicates with the secondary second internal chamber 3172.

Referring to FIG. 3B again, the piezoelectric actuating element 310 is disposed at the first internal chamber 3160 to compress the space of the first internal chamber 3160. It can be seen in FIG. 3B, the piezoelectric actuating element 310 at least includes a piezoelectric piece 3100, which is made of piezoelectric material normally with a thickness in a range between 0.1 μm and 3,000 μm, and a metal diaphragm 3110, which tightly contacts with a surface of the piezoelectric piece 3100 and is made of nickel, cobalt-nickel, stainless steel, titanium, copper or brass. The thickness of the metal diaphragm 3110 is in a range between 5 μm and 1,000 μm, a metal diaphragm 3110.

Further, the valve parts 318, 319 of the micro pump 3 shown in FIG. 3B employ the second embodiment of the valve structure according to the present invention. Of course, the first embodiment of the valve structure according to the present invention can be used instead. Alternatively, all both the embodiments of the valve structure of the present invention are capable of being provided with the micro pump 3 and the advantageous effect can be maintained as well. The valve parts 318, 319 further includes seal rings 3184, 3194 in addition to the parts provided in the second embodiment of the present invention. The seal rings 3184, 3194 are closely touched to a surface of the valve diaphragms 3182, 3192 respectively to seal the circumferences of the valve diaphragms 3182, 3192 firmly.

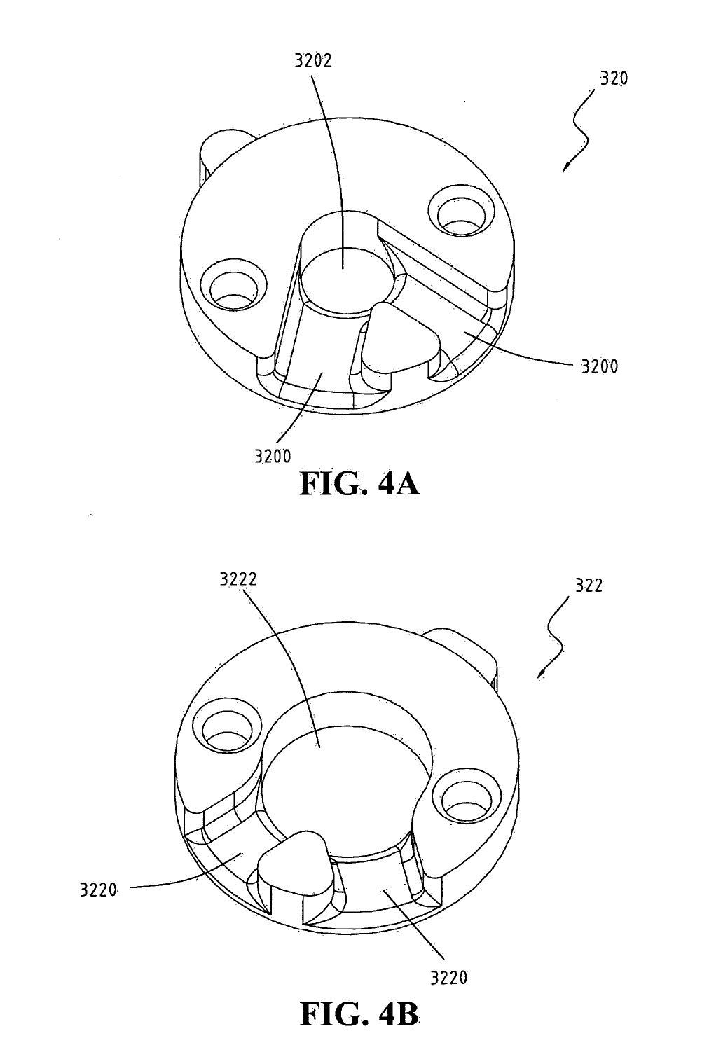

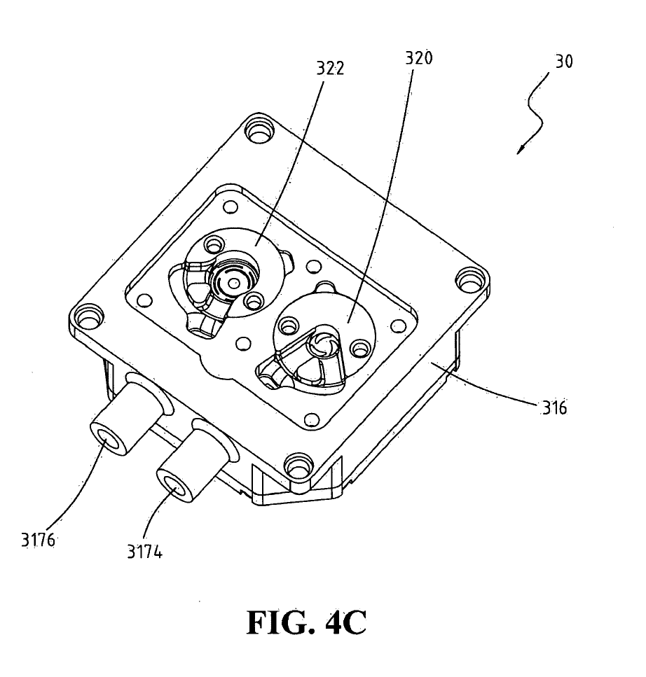

The parts of the micro pump 3 shown in FIG. 3B further includes a first washer 302, a driving circuit board 304, a support ring 306, a second washer 308, an isolation diaphragm 312, a third washer 314, an inlet path lid 320, an outlet path lid 322 and a packing 324. The driving circuit 304 is provided to drive the piezoelectric actuating element 310. The first washer 302 is sandwiched between the upper cover plate 300 and the driving circuit 304. The support ring 306 is sandwiched between the driving circuit board 304 and the second washer 308. The isolation diaphragm 312 closely touches a side of the piezoelectric actuating element 310 to prevent the piezoelectric actuating element 310 from contacting special fluid directly. Thus, the isolation diaphragm 312 provides properties such as anticorrosion, anti-acid and anti-alkali, high-temperature strength and insulation such that the material thereof is selected from high grade engineering plastics, polytetrachlorethylene, polyether-ether-ketone, polyimide, polyetherimide, silicon carbide and silicon oxide. The third washer 314 is sandwiched between the isolation diaphragm 312 and the main body 316 of the casing 30. The packing 324 is sandwiched between the main body 316 and the lower cover plate 326 to prevent the fluid from leaking via a clearance between the lower cover plate 326 and main body 316. The inlet path lid 320 and the outlet path lid 322 with the structures and positions thereof will be described afterward in detail in company with illustration of FIGS. 4A and 4B.

The fluid entry 3174 and the fluid exit 3176 of the micro pump 3 can be disposed in a way different from being positioned at the same side wall of the casing 30 as shown in FIG. 3A. That is, the fluid entry 3174 is arranged at one side wall of the casing 30 and the fluid exit 3176 is arranged at another side wall of the casing 30. It can be seen in FIG. 3E that the fluid entry 3174 and the fluid exit 3176 are disposed at two adjacent side walls respectively. Further, it can be implemented that the fluid entry 3174 is arranged at one of the side walls of the casing 30 and the fluid exit 3176 is arranged at the bottom wall of the casing 30 as shown in FIG. 3F or the fluid exit 3176 is arranged at one of the side walls of the casing 30 and the fluid entry 3174 is arranged at the bottom wall of the casing 30.

Referring to FIGS. 4A, 4B and 4C, the inlet path lid 320 and the outlet path lid 322 are illustrated. It can be seen in FIG. 4C that the inlet path lid 320 is disposed at the primary second internal chamber 3170 of the casing 30 and the outlet path lid 322 of the casing 30 is disposed at the secondary second internal chamber 3172. FIG. 4A shows the inlet path lid 320 at least has an inlet furrow 3200 and a collecting hole 3202 and the inlet furrow 3200 communicates with fluid entry 3174 and the collecting hole 3202. FIG. 4B shows the outlet path lid 322 at least has an outlet furrow 3220 and an outgoing hole 3222 and the outlet furrow 3220 communicates with fluid exit 3176 and the outgoing hole 322. Besides, it can be learned the collecting hole 3202 closely attaches a side of the valve parts 318 of the inlet 3162 provided in the casing 30 and the outgoing hole 3222 closely attaches a side of the valve parts 319 of the outlet 3164 provided in the casing 30. Further, the collecting hole 3202 provides a size less than the inlet 3162 and the outgoing hole 3222 provides a size greater than the outlet 3164.

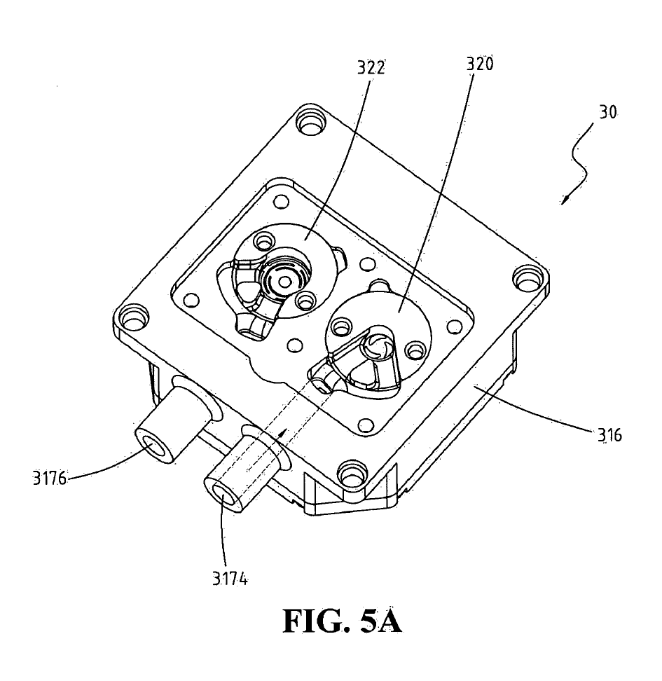

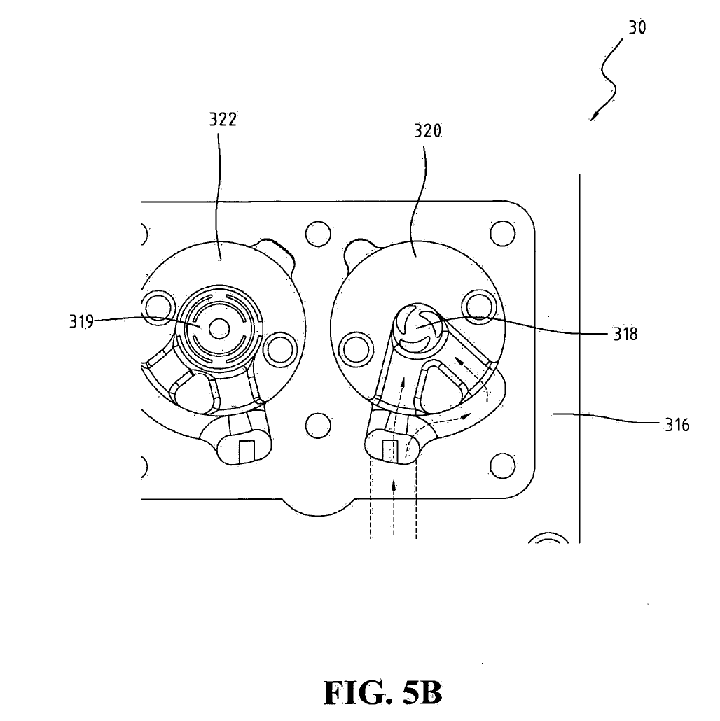

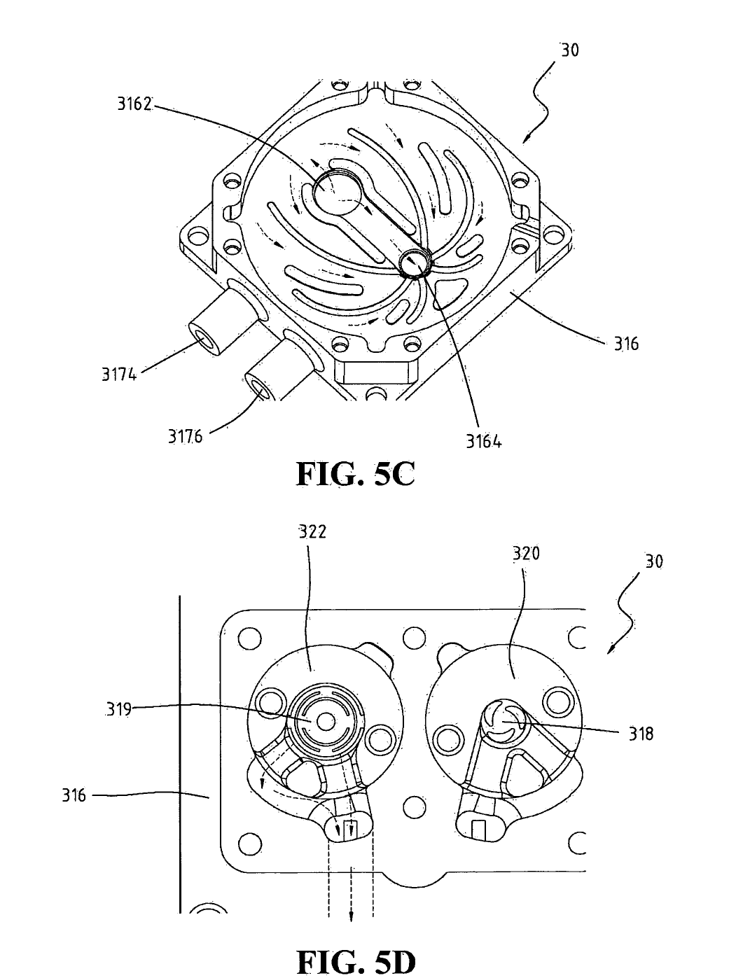

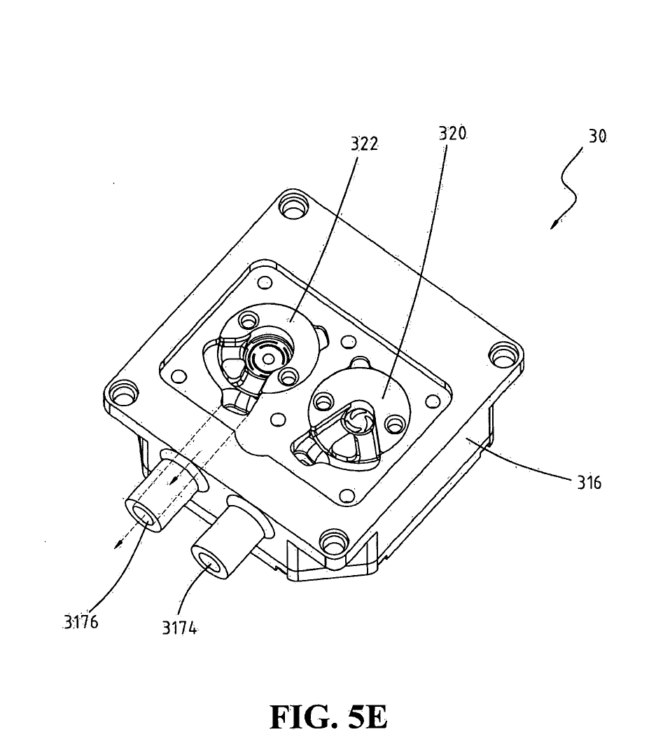

Referring to FIGS. 5A and 5B, the fluid entering the fluid entry 3174 of the micro pump 3 and moving along the inlet furrow 3200 of the inlet path lid 320 is illustrated. The fluid is collected with the collecting hole 3202 before passing through the valve parts 318 after entering the fluid entry 3174 and flowing along the inlet furrow 3200 of the inlet path lid 320.

Referring to FIG. 5C, the fluid leaving the fluid entry toward the fluid exit is illustrated. The fluid flows outward the inlet 3162 after passing through the valve parts 318 and moves toward the outlet 3164 gradually under being guided by the guide projections 3168 and the leading recesses 3166.

Referring to FIG. 5D, the fluid passing through the outlet furrow 3220 of the outlet path lid 322 is illustrated. The fluid flows outward the outgoing hole 3222 after passing through the valve parts 319 disposed at the outlet 3164 and then moves along the outlet furrow 3220. Finally, the fluid moves out of the micro pump 3 via the fluid exit 3176 as shown in FIG. 5E.

The upper cover plate 300 and the lower cover plate 326 can be joined to the main body 316 of the micro casing 30 with supersonic welding and hot pressing welding in addition to with screw fasteners 328 as shown in FIG. 3B.

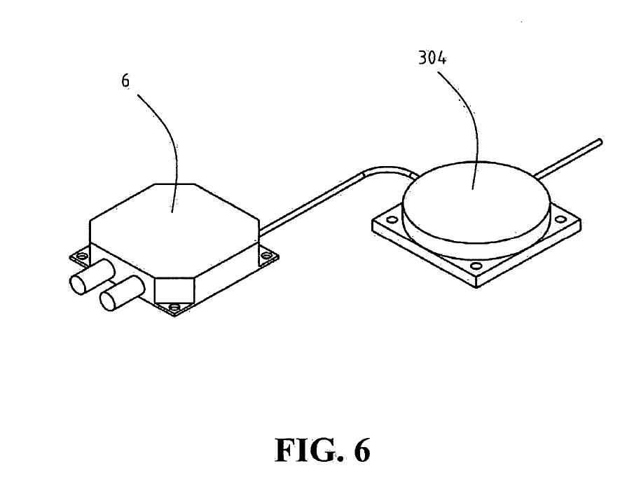

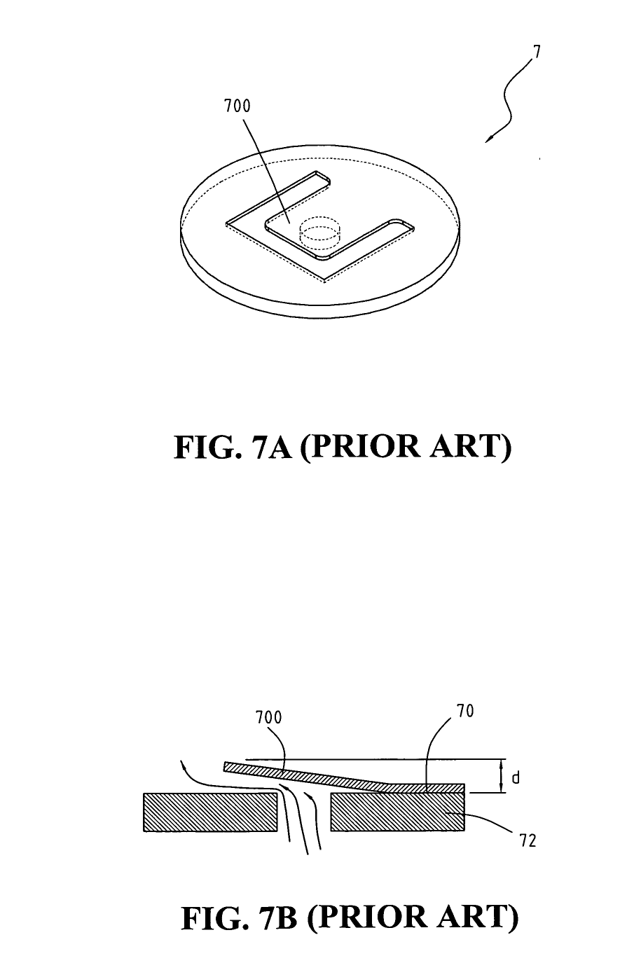

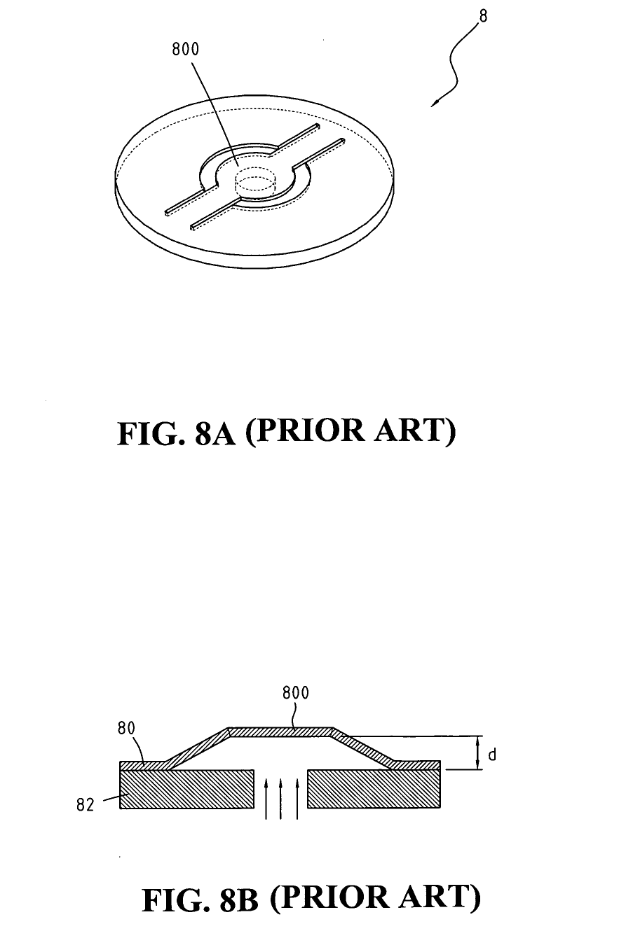

Referring to FIG. 6, a variation of the micro pump containing a valve according to the present invention is illustrated. In order to reduce the volume of the micro pump, the driving circuit 304 is electrically connected to the piezoelectric actuating element in the micro pump 6 externally as shown in FIG. 6.

It is appreciated that the advantages and the effectiveness of the present invention can be summarized in the following:

1. The valve opening 100 at the center of the valve opening diaphragm 10 in the first embodiment of the valve structure according to the present invention provides a plurality of wave shaped projections to offer a larger circumferential length of the valve opening 100 such that it is capable of obtaining a larger cross section of effective flow path.

2. The valve opening 100 with a plurality of wave shaped projections in the first embodiment of the valve structure according to the present invention has a function of guiding the fluid flow for opening and closing operation of the valve being performed normally to prevent from being affected with the turbulent flow field.

3. The support point of the area 122 of the valve diaphragm 12, which is provided in the first embodiment of the valve structure according to the present invention to corresponds to the valve opening diaphragm 10, is located to close to the center thereof such that the area 122 is capable of subjecting to greater pressure difference without being plastically deformed.

4. When the valve in the first embodiment of the present invention operates to open or close, the area 122 of the valve diaphragm 12 moves in a way of approximately parallel to the valve opening diaphragm 10 to enhance efficiency of opening and closing effectively.

5. The valve opening 200 of the valve opening diaphragm 20 in the second embodiment of the valve structure according to the present invention provides a half-moon shaped opening to guide the fluid flow such that the valve is capable of performing operations of opening and closing normally without being affected by the turbulent flow field.

6. The support area of the area 222 of the valve diaphragm 22, which is provided in the second embodiment of the valve structure according to the present invention to correspond to the valve opening diaphragm 20, is increased such that the area 222 is capable of subjecting to greater pressure difference without being plastically deformed.

7. The valve structure in the second embodiment not only offers a larger cross section of effective flow path at the time of the valve opening but also the area 222 of the valve diaphragm 22 moves approximately parallel to the valve opening diaphragm 20 to enhance efficiency of opening and closing effectively at the time of the valve opening and closing.

While the invention has been described with referencing to preferred embodiments thereof, it is to be understood that modifications or variations may be easily made without departing from the spirit of this invention, which is defined by the appended claims.

What is claimed is:

1. A valve structure comprising:
a valve opening diaphragm providing a central valve opening with a plurality of wave shaped projections at the circumference of said valve opening; and
a valve diaphragm stacking on said valve opening diaphragm and providing at least a pair of elongated circular grooves;
wherein, said pair of circular grooves are symmetrically disposed with respect to the center of said valve diaphragm and an area enclosed by said pair of circular grooves covers said valve opening.

2. The valve structure as defined in claim 1, wherein the number of said wave shaped projections is “n” and n=2,3,4, . . . ,360.

3. The valve structure as defined in claim 1, wherein the area enclosed by said pair of circular grooves is a disk area.

4. The valve structure as defined in claim 1, further comprise a seal ring closely touching a surface of said valve diaphragm.

5. The valve structure as defined in claim 1, wherein said valve opening diaphragm is a thin disk piece, a thin triangular piece or a thin polygon piece.

6. The valve structure as defined in claim 1, wherein said valve diaphragm is a thin disk piece, a thin triangular piece or a thin polygon piece.

7. The valve structure as defined in claim 6, wherein said valve diaphragm provides multiple pairs of elongated circular grooves and each pair of elongated circular grooves are circumferentially disposed with an equal radius.

8. The valve structure as defined in claim 1, wherein said valve opening diaphragm is made of polytetrachlorethylene, polyether-ether-ketone, polyimide, polyetherimide, or high grade engineering plastics.

9. The valve structure as defined in claim 1, wherein said valve diaphragm is made of polytetrachlorethylene, polyether-ether-ketone, polyimide, polyetherimide, or high grade engineering plastics.

10. The valve structure as defined in claim 1, wherein said valve opening diaphragm provides a thickness with a range between 0.1 μm and 500 μm.

11. The valve structure as defined in claim 1, wherein said valve diaphragm provides a thickness with a range between 1 μm and 2000 μm.

12. A valve structure comprising:
a valve opening diaphragm with a center providing a plurality of valve openings being disposed in a way of being equidistant to said center; and
a valve diaphragm stacking on said valve opening diaphragm, providing a central hole and at least a pair of elongated circular grooves;
wherein, said pair of circular grooves are symmetrically disposed with respect to the center of said valve diaphragm and an area surrounding said central hole and enclosed by said pair of circular grooves covers said valve openings.

13. The valve structure as defined in claim 12, further comprise a seal ring closely touching a surface of said valve diaphragm.

14. The valve structure as defined in claim 12, wherein the number of said valve openings are “n” and n=2,3,4, . . . ,360.

15. The valve structure as defined in claim 12, wherein said valve openings are half-moon shaped openings.

16. The valve structure as defined in claim 12, wherein the area surrounding said hole and enclosed by said pair of circular grooves is a disk area.

17. The valve structure as defined in claim 12, wherein said valve opening diaphragm is a thin disk piece, a thin triangular piece or a thin polygon piece.

18. The valve structure as defined in claim 12, wherein said valve diaphragm is a thin disk piece, a thin triangular piece or a thin polygon piece.

19. The valve structure as defined in claim 18, wherein said valve diaphragm provides multiple pairs of elongated circular grooves and each pair of elongated circular grooves are circumferentially disposed with an equal radius.

20. The valve structure as defined in claim 12, wherein said valve opening diaphragm is made of polytetrachlorethylene, polyether-ether-ketone, polyimide, polyetherimide, or high grade engineering plastics.

21. The valve structure as defined in claim 12, wherein said valve diaphragm is made of polytetrachlorethylene, polyether-ether-ketone, polyimide, polyetherimide, or high grade engineering plastics.

22. The valve structure as defined in claim 12, wherein said valve opening diaphragm provides a thickness with a range between 0.1 μm and 500 μm.

23. The valve structure as defined in claim 12, wherein said valve diaphragm provides a thickness with a range between 1 μm and 2000 μm.

24. A micro pump for conveying fluid comprising:
a casing providing a first internal chamber, an entry and an exit;
a piezoelectric actuating element being disposed at said first internal chamber to compress a space in said first internal chamber; and
a plurality of valve parts being disposed at said entry and said exit respectively; wherein said valve parts further at least comprises:
a valve opening diaphragm providing a central valve opening with a plurality of wave shaped projections at the circumference of said valve opening; and
a valve diaphragm stacking on said valve opening diaphragm and providing at least a pair of elongated circular grooves;
wherein, said pair of circular grooves are symmetrically disposed with respect to the center of said valve diaphragm and an area enclosed by said pair of circular grooves covers said valve opening.

25. The micro pump as defined in claim 24, wherein said casing forms a bottom wall of said first internal chamber with a plurality of guide flow projections and leading recesses, said leading recesses extends outward circumferentially from said outlet and said guide flow projections are arranged between said leading recesses.

26. The micro pump as defined in claim 24, wherein said casing provides a primary second internal chamber, a secondary second internal chamber, a fluid entry and a fluid exit in a way of said fluid entry communicates with said primary second internal chamber and said fluid exit communicates with said secondary second internal chamber.

27. The micro pump as defined in claim 26, further comprises:
an inlet path lid being disposed at said primary second internal chamber with at least an inlet furrow and a collecting hole, said inlet furrow communicates with said fluid entry and said collecting hole and said collecting hole closely touching a side of said valve parts next to said inlet; and
an outlet path lid being disposed at said secondary second internal chamber with at least an outlet furrow and an outgoing hole, said outlet furrow communicates with both said fluid exit and said outgoing hole and said outgoing hole closely touching another side of said valve parts next to said outlet.

28. The micro pump as defined in claim 27, wherein said casing has an upper cover plate and a lower cover plate.

29. The micro pump as defined in claim 28, further comprises a driving circuit board for driving said piezoelectric actuating element.

30. The micro pump as defined in claim 28, further comprises a first washer being sandwiched between said upper cover plate and said driving circuit board.

31. The micro pump as defined in claim 30, further comprises a support ring first washer being sandwiched between said driving circuit board and a second washer.

32. The micro pump as defined in claim 31, further comprises a second washer being sandwiched between said support ring and said piezoelectric actuating element.

33. The micro pump as defined in claim 31, further comprises an isolation diaphragm closely touching a side of said piezoelectric actuating element.

34. The micro pump as defined in claim 33, further comprises a third washer being sandwiched between said isolation diaphragm and the main body of said casing.

35. The micro pump as defined in claim 34, further comprises a packing being sandwiched between the main body of said casing and said lower cover plate.

36. The micro pump as defined in claim 24, wherein said piezoelectric actuating element at least a piezoelectric piece, which is a thin sheet made of piezoelectric material.

37. The micro pump as defined in claim 36, wherein said piezoelectric actuating element further comprises a metal diaphragm, which closely touches a surface of said piezoelectric actuating element.

38. The micro pump as defined in claim 37, wherein said metal diaphragm is made of nickel, cobalt-nickel, stainless steel, titanium, copper or brass.

39. The micro pump as defined in claim 36, wherein said piezoelectric actuating element has a thickness with a range between 0.1 μm and 3000 μm.

40. The micro pump as defined in claim 37, wherein said metal diaphragm has a thickness with a range between 0.1 μm and 3000 μm.

41. The micro pump as defined in claim 33, wherein said isolation diaphragm is made of high grade engineering plastics, polytetrachlorethylene, polyether-ether-ketone, polyimide, polyetherimide, silicon carbide and silicon oxide.

42. The micro pump as defined in claim 24, wherein said valve parts further comprises a seal ring closely touches a surface of said valve diaphragm.

43. The micro pump as defined in claim 27, wherein said collecting hole provides a size less than said inlet and said outgoing hole is greater than said outlet.

44. The micro pump as defined in claim 29, wherein said driving circuit board is electrically connected to said piezoelectric actuating element externally.

45. The micro pump as defined in claim 31, wherein the fluid is liquid or gas.

46. The micro pump as defined in claim 45, wherein the liquid is diesel oil, gasoline, methanol, alcohol, pure water, methanol solution, alcohol solution, liquid chemical drug or sea water.

47. The micro pump as defined in claim 45, wherein the gas is natural gas, hydrogen, pure oxygen, air or carbon oxide.

48. The micro pump as defined in claim 28, wherein said upper cover plate and lower cover plate are attached to the main body of said casing by means of screw fastening.

49. The micro pump as defined in claim 28, wherein said upper cover plate and lower cover plate are attached to the main body of said casing by means of supersonic welding.

50. The micro pump as defined in claim 28, wherein said upper cover plate and lower cover plate are attached to the main body of said casing by means of hot press welding.

51. The micro pump as defined in claim 26, wherein said fluid entry and said fluid exit are provided at the same side wall of said casing.

52. The micro pump as defined in claim 26, wherein said fluid entry is provided at a side wall of said casing and said fluid exit is provided at another side wall of said casing.

53. The micro pump as defined in claim 26, wherein said fluid entry is provided at a side wall of said casing and said fluid exit is provided at the bottom wall of said casing.

54. The micro pump as defined in claim 26, wherein said fluid exit is provided at a side wall of said casing and said fluid entry is provided at the bottom wall of said casing.

55. A micro pump for conveying fluid comprising:
a casing providing a first internal chamber, an inlet and an outlet;
a piezoelectric actuating element being disposed at said first internal chamber to compress a space in said first internal chamber; and
a plurality of valve parts being disposed at said inlet and said outlet respectively; wherein said valve parts further at least comprises:
a valve opening diaphragm with a center providing a plurality of valve openings being disposed in a way of being equidistant to said center; and
a valve diaphragm stacking on said valve opening diaphragm, providing a central hole and at least a pair of elongated circular grooves;
wherein, said pair of circular grooves are symmetrically disposed with respect to the center of said valve diaphragm and an area surrounding said central hole and enclosed by said pair of circular grooves covers said valve openings.

56. The micro pump as defined in claim 55, wherein said casing forms a bottom wall of said first internal chamber with a plurality of guide flow projections and leading recesses, said leading recesses extends outward circumferentially from said outlet and said guide flow projections are arranged between said leading recesses.

57. The micro pump as defined in claim 55, wherein said casing provides a primary second internal chamber, a secondary second internal chamber, a fluid entry and a fluid exit in a way of said fluid entry communicates with said primary second internal chamber and said fluid exit communicates with said secondary second internal chamber.

58. The micro pump as defined in claim 57, further comprises:
an inlet path lid being disposed at said primary second internal chamber with at least an inlet furrow and a collecting hole, said inlet furrow communicates with said fluid entry and said collecting hole and said collecting hole closely touching a side of said valve parts next to said inlet; and
an outlet path lid being disposed at said secondary second internal chamber with at least an outlet furrow and an outgoing hole, said outlet furrow communicates with both said fluid exit and said outgoing hole and said outgoing hole closely touching another side of said valve parts next to said outlet.

59. The micro pump as defined in claim 58, wherein said casing has an upper cover plate and a lower cover plate.

60. The micro pump as defined in claim 59, further comprises a driving circuit board for driving said piezoelectric actuating element.

61. The micro pump as defined in claim 59, further comprises a first washer being sandwiched between said upper cover plate and said driving circuit board.

62. The micro pump as defined in claim 61, further comprises a support ring first washer being sandwiched between said driving circuit board and a second washer.

63. The micro pump as defined in claim 62, further comprises a second washer being sandwiched between said support ring and said piezoelectric actuating element.

64. The micro pump as defined in claim 62, further comprises an isolation diaphragm closely touching a side of said piezoelectric actuating element.

65. The micro pump as defined in claim 64, further comprises a third washer being sandwiched between said isolation diaphragm and the main body of said casing.

66. The micro pump as defined in claim 65, further comprises a packing being sandwiched between the main body of said casing and said lower cover plate.

67. The micro pump as defined in claim 55, wherein said piezoelectric actuating element at least a piezoelectric piece, which is a thin sheet made of piezoelectric material.

68. The micro pump as defined in claim 67, wherein said piezoelectric actuating element further comprises a metal diaphragm, which closely touches a surface of said piezoelectric actuating element.

69. The micro pump as defined in claim 68, wherein said metal diaphragm is made of nickel, cobalt-nickel, stainless steel, titanium, copper or brass.

70. The micro pump as defined in claim 67, wherein said piezoelectric actuating element has a thickness with a range between 0.1 μm and 3000 μm.

71. The micro pump as defined in claim 68, wherein said metal diaphragm has a thickness with a range between 0.1 μm and 3000 μm.

72. The micro pump as defined in claim 64, wherein said isolation diaphragm is made of high grade engineering plastics, polytetrachlorethylene, polyether-ether-ketone, polyimide, polyetherimide, silicon carbide and silicon oxide.

73. The micro pump as defined in claim 55, wherein said valve parts further comprises a seal ring closely touches a surface of said valve diaphragm.

74. The micro pump as defined in claim 58, wherein said collecting hole provides a size less than said inlet and said outgoing hole is greater than said outlet.

75. The micro pump as defined in claim 60, wherein said driving circuit board is electrically connected to said piezoelectric actuating element externally.

76. The micro pump as defined in claim 55, wherein the fluid is liquid or gas.

77. The micro pump as defined in claim 76, wherein the liquid is diesel oil, gasoline, methanol, alcohol, pure water, methanol solution, alcohol solution, liquid chemical drug or sea water.

78. The micro pump as defined in claim 76, wherein the gas is natural gas, hydrogen, pure oxygen, air or carbon oxide.

79. The micro pump as defined in claim 59, wherein said upper cover plate and lower cover plate are attached to the main body of said casing by means of screw fastening.

80. The micro pump as defined in claim 59, wherein said upper cover plate and lower cover plate are attached to the main body of said casing by means of supersonic welding.

81. The micro pump as defined in claim 59, wherein said upper cover plate and lower cover plate are attached to the main body of said casing by means of hot press welding.

82. The micro pump as defined in claim 57, wherein said fluid entry and said fluid exit are provided at the same side wall of said casing.

83. The micro pump as defined in claim 57, wherein said fluid entry is provided at a side wall of said casing and said fluid exit is provided at another side wall of said casing.

84. The micro pump as defined in claim 57, wherein said fluid entry is provided at a side wall of said casing and said fluid exit is provided at the bottom wall of said casing.

85. The micro pump as defined in claim 57, wherein said fluid exit is provided at a side wall of said casing and said fluid entry is provided at the bottom wall of said casing.
